(19) United States
(12) Patent Application Publication
(10) Pub. No.: US 2008/0313205 A1
(43) Pub. Date: Dec. 18, 2008

(54) Card Design System

(75) Inventors: Adam Elgar, Brooklyn, NY (US); Tom Elgar, London (GB); James Pendley, London (GB); Michael Pollitt, London (GB)

Correspondence Address: MCDERMOTT WILL & EMERY LLP, 18191 VON KARMAN AVE., SUITE 500, IRVINE, CA, 92612-7108, US

(73) Assignee: Serverside Group Limited, London (GB)

(21) Appl. No.: 11/659,470

(22) PCT Filed: Aug. 17, 2005
(86) PCT No.: PCT/GB05/03217

§ 371 Date: Aug. 19, 2008

(30) Foreign Application Priority Data
Aug. 17, 2004 (GB) GB2004/003537

(51) Int. Cl. G06F 17/00; G06F 19/00

(52) U.S. Cl. 707/102; 700/108; 358/1.6; 707/E17.001

(57) ABSTRACT

The present invention relates to a service provider connected to a database for storing a plurality of images having associated unique identifiers. The service provider comprising a first interface for enabling a user to select at least one of the plurality of images to be displayed on a transaction card. The service provider also comprising a second interface for enabling a card issuer to upload a stock image to the database and for assigning a unique stock identifier to said stock image.

The present invention relates to creating a transaction card and in particular, but not exclusively, to providing an interface for enabling a card issuer to upload images to a database.

There has been an increasing consumer desire for self-differentiation, particularly for differentiating mass-marketed personal items. This can be clearly seen in the recent popularity of customized mobile phone ring-tones and fascias. Indeed users of a particular mobile phone operator are able to download ringtones and occasional software updates, which might change the appearance of the display on a mobile phone. The internet has thus become a useful tool for users seeking to update their current products.

Typically in the past, financial transaction cards, such as credit cards have remained un-personalised in appearance; perhaps due to anticipated difficulties in allowing a user to personalize the appearance of an item such as a credit card while also maintaining the overall security for the user's private financial information.

Developers of systems capable of applying personalized images to financial transaction cards of users consider it a high priority to provide secure technical means for providing information capable of associating user identities and/or account information with their personalized image.

The international application PCT/GB2004/000626 published on 2 Sep. 2004 describes a system for allowing a user to manipulate images stored at a remote image server over the Internet and for applying these to a personalised credit card.

Although the user is able to select the images or design for a credit card, a further process is required whereby such information will need to be passed onto a card issuer and/or a card producer for approval or to confirm that such a design is feasible.

It is an aim of an embodiment of the present invention to remove such a further process.

Moreover, images for card often need to be printed in batches and could involve printing images on both a front and rear face of a card.

It is aim of an of an embodiment of the present invention to improve the processes for printing said cards.

Also, there are many successive stages of manufacture that a transaction card needs to undergo from printing to delivery to the user, wherein errors can creep in at any of these stages, and yet still be passed to further stages for processing.

It is an aim of a further embodiment of the present invention to identify the stages where said errors occur.

According to one aspect of the present invention there is provided a method for uploading a stock image to a database which is able to be selected for display on a transaction card, the method comprising: selecting the stock image at a card issuer; uploading said stock image from the card issuer to the database; and selecting from said database a stock image to be displayed on a transaction card.

One of the advantages of the card issuer or their representatives being able to upload stock images to the database is that the card issuer can deliver a new card design (pretty plastic) to the market in minutes—as soon as the image is uploaded and activated on the management site it could be select by the consumer on a related website. It can therefore be used to deliver event-based marketing pushes. Furthermore, as the cards are printed one by one based on demand there is no loss to the marketer from have many card designs as the same time and producing many niche products—such as a Formula One card or a Wildlife card each with dozens, hundreds or even thousands of designs.

In addition it would be possible to add card design functionality to the system so that a new card need not be designed by a professional but by the marketer. By adding simple functionality to ensure that an image is of sufficient quality (by checking on the size in pixels and kb for example) the system can ensure that the marketer is unlikely to make a mistake in designing the card.

According to one aspect of the present invention there is provided a service provider connected to a database for storing a plurality of images having associated unique identifiers, the service provider comprising: a first interface for enabling a user to select at least one of the plurality of images to be displayed on a transaction card; a second interface for enabling a card issuer to upload a stock image to the database.

According to another aspect of the present invention there is provided a method of printing images on sheets, the method comprising: receiving a sheet fed sequentially from an input hopper; printing a first set of images onto the sheet at locations defined by a predetermined grid pattern in a first order, and wherein duplex data is also printed onto the sheet; reading said duplex data printed on the sheet; and based thereon, orientating a next sheet so that a second set of images is printed at the locations defined by the grid pattern in a different order.

According to another aspect of the present invention there is provided a method of printing a plurality of images for transaction cards each having a rear and front face capable of displaying an image, the method comprising: a first pass printing process for printing a first set of images for one of front and rear face of the cards, wherein the images are printed on a sheet in a first configuration within a predetermined grid pattern; inverting the sheet about a predetermined axis; a second printing pass for printing a second set of images for the other face of the cards on the inverted sheet, wherein the second set of images are printed in a second configuration within the grid pattern and being orientated so that said other images are printed on the other face of the corresponding card.

According to another aspect of the present invention there is provided a printer apparatus connected to a database for a plurality of images and unique identifiers associated with each image, the printer apparatus comprising: an input hopper for feeding a sheet; a print unit for receiving each sheet and printing thereon a first set of images at least some of which are different, in a first order at locations defined according to a predetermined pattern, and printing information on the sheet; an output hopper for maintaining the printed sheets sequentially; and a reader for reading the information and based thereon, orientating the next sheet so that a second set of images is printed at the locations in a different order.

Preferably, wherein the set of data records is instead either associated with a sheet of images or a batch of sheets.

According to another aspect of the present invention there is provided a method for checking the validity of a transaction card as it proceeds through successive stages of manufacture, the method comprising: printing an image and a unique identifier associated with that image on a transaction card; proceeding through each subsequent stage, wherein after each stage, the unique identifier is checked; and based thereon identifying whether at any stage the card is invalid thereby generating an exception and preventing the card from proceeding to any successive stages.

Preferably wherein in response to the step of generating the exception, there is a further step of enabling the reprint of the card (or sheet of cards, or batch of sheets of cards) at this point.

Preferably, wherein the initial printing stage of manufacture is triggered by at least one of: receiving in a database a record comprising the image and the unique identifier assigned to the image; receiving an exception which requires a remanufacturing of the invalid transaction card or receiving a reference of an embossing record to a stock image maintained in the database.

According to another aspect of the present invention there is provided a method of manufacturing a transaction card displaying a selected image, the method comprising: proceeding through a sequence of manufacturing stages, wherein after each stage, a unique identifier associated with the image is checked; generating an exception if the check is invalid; and triggering a new manufacturing sequence for a new transaction card in response to receiving the exception.

According to yet another aspect of the present invention there is provided a method for checking the validity of a transaction card during production, the method comprising: printing an image and a unique identifier associated with that image on a transaction card; reading the unique identifier and based thereon checking whether the card is invalid; and wherein if the card is invalid, raising an exception for discarding the card and returning to an upstream printing step for reprinting the image and the unique identifier.

According to yet another aspect of the present invention there is provided a method of producing a plurality of transaction cards, the method comprising: providing an identifier associated with one or more cards in the production process; monitoring production of the plurality of cards to observe at least one spoiled card; reading said identifier to generate an exception record indicating at least one card needing to be re-printed; and controlling the production process so as to automatically reconfigure a print queue to produce a fresh version of the or each spoiled card.

### LIST OF DRAWINGS

For a better understanding of the present invention and to show how the same may be carried into effect, reference will now be made by way of example to the accompanying drawings:

FIG. 1 shows a basic communications architecture for contextualising embodiments of the present invention;

FIG. 2 shows an example of a personalised credit card;

FIG. 3 shows a flow chart representing the preferred embodiments of the present invention;

FIG. 4 shows a web page interface for the card issuer according to an embodiment of the present invention;

FIG. 5 shows an image library of templates that may be selected;

FIG. 6 shows an enlarged view of a selected image;

FIG. 7 shows a webpage showing relevant reporting metrics to the card issuer;

FIG. 8 shows a printing apparatus according to an embodiment of the present invention; and

FIG. 9 shows the print configurations for the two-pass printing embodiment of the present application.

### DESCRIPTION

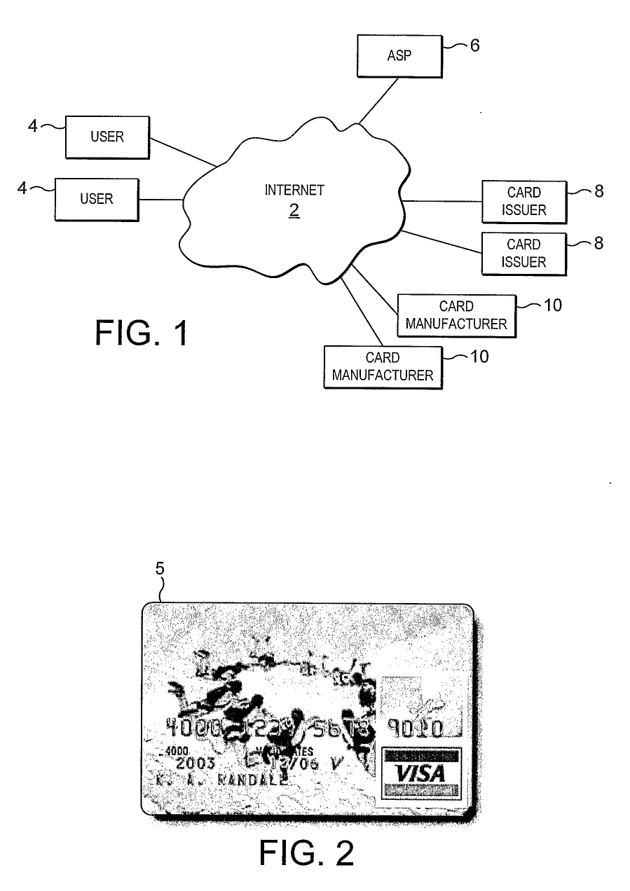

FIG. 1 shows the basic architecture of the various structural elements which provide a context for the present application. Specifically, various entities are shown as being interconnected via the internet 2. There are a plurality of users 4 which are able to connect to an application service provider (ASP) 6. The ASP 6 provides a software interface, for example a server website, which allows the users 4 to utilise the software provided by the ASP in order to personalize images to be displayed on a financial transaction card, for example a credit card. An example of this is shown in FIG. 2 where a credit card has been personalized by selecting a specific image on the front of the credit card 5 showing a ring of sky divers.

The user may in certain circumstances also be able to connect to a card issuer 8 and, for example, request an online application form for a personalized transaction card or go to the branch and pick up the relevant application form.

The card issuer 8 is also able to communicate separately with the ASP 6 according to a preferred embodiment of the present invention which will be described in more detail later.

FIG. 1 also shows a plurality of card manufacturers 10, wherein each card manufacturer comprises equipment for the printing and manufacture of a transaction card once a personalized image or stock image has been selected, which will also be explained in more detail later. It should be appreciated that the card manufacturer 10 may be a third party trusted by a relevant card issuer 8 or alternatively the card manufacturing functionality 10 can be owned by the card issuer 8 and/or located physically onsite. Further the ASP may be physically located within the card issuer or card manufacturer environments.

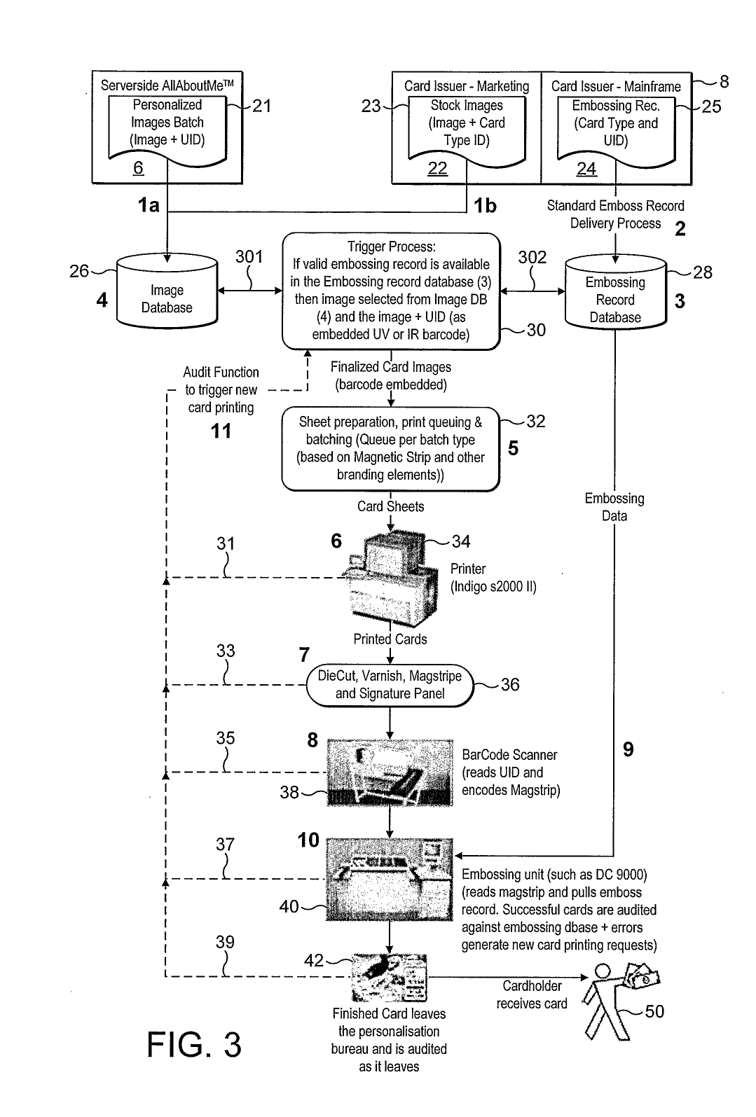

FIG. 3 shows a flowchart indicating the various embodiments of the present application. According to a one embodiment, FIG. 3 shows an application service provider 6 comprising a batch of personalized images 21, wherein said batch of personalized images comprises a unique identifier (UID) which is assigned to each personalized image generated. Thus, a batch of records each comprising an image and an associated UID is sent along a line 1a to be stored in an image database 26 for processing.

FIG. 3 also shows a card issuer 8 comprising marketing functionality 22 and mainframe functionality 24. The marketing functionality 22 having stock image records 23 comprising so-called stock images and associated card type UID's (or stock UID's). The stock images being images which are uploaded by the card issuer to the image database 26. That is, the card issuer can either design and/or decide on which images he is prepared to allow. In this way, the card issuer can restrict the user to use stock images that have been approved by the card issuer, to be selected by the user for their personalized transaction card. Thus, it can be seen that the image database 26 can comprise different types of records for example one set of records from the ASP 6 which would be personalized images designed by the user, and a second set of records 23 which comprise stock images as provided by the card issuer.

According to an embodiment of the present invention, the ASP 6 provides an external facing portal allowing card issuers to upload, activate, deactivate or delete their own stock card images. Thus, FIG. 3 shows that the image database 26, which in a preferred embodiment is stored in the ASP 6, can be manipulated by the card issuer 22 along line 10. It should be appreciated that in alternative embodiments, the database 26 can be located remotely from the ASP 6, but still connected over the Internet 2.

According to a preferred embodiment, the external facing portal is an interface which will be supplied through an internet website wherein it should be appreciated that the website could be hosted at any location connected to the internet, for example at the card manufacturer 10 or at a web server farm with a link to ensure the passing of data between the physical location of the card issuer and the location of where the interface website is hosted.

It is also appreciated that access to the stock image portal in the ASP may be protected using a login, for example comprising a user name and password, which could also be used to display the correct information to the relevant card issuer upon login. It should be appreciated that a VPN (virtual private network) or other security protocol can also be used.

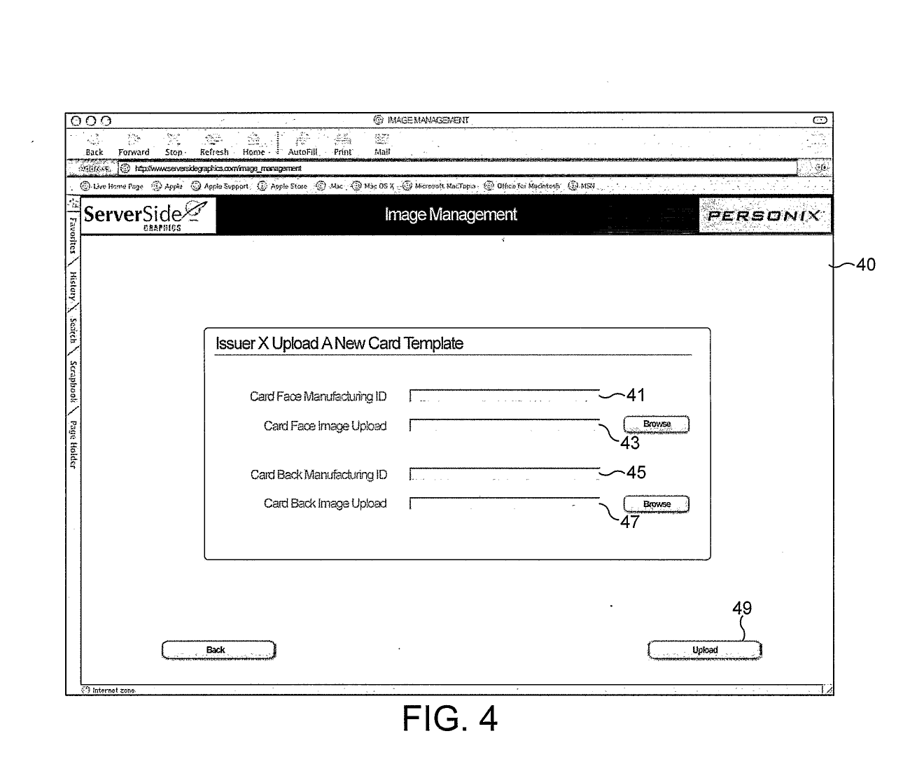

FIG. 4 shows an example of an image upload page which forms part of the interface providing card issuer 8 with the ability to remotely upload their stock card images into the database 26, which is connected to the ASP 6 for selection by a user.

FIG. 4 shows an image upload page which provides fields for allowing a card issuer to assign a stock UID for the card type. This assignation could include both the definitions of respective images associated with a front and rear face of the transaction card. Thus, FIG. 4 shows a screen which enables a card issuer to create a new card template defining images which are to be displayed on the respective front and rear faces of a payment card.

For example a card issuer would select an image for the front face of the card by clicking on the browse field 43 and selecting the relevant image from a local directory, for example stored at the card issuer. The card issuer is then able to assign a stock UID to the selected image for the front of the card by entering this stock UID into field 41. Likewise, the card issuer is able to undergo the same process in selecting an image to be displayed on the rear of the card at field 47 and assigning a stock UID to this image using field 45. Once all of the relevant information has been inserted, the card issuer can then click on the UPLOAD button 49 which will automatically upload a new card template comprising associated records for the front and rear of the card which are then uploaded to the database 26 over line 10. Alternatively the stock card UID may be generated at this point and reported back to the card issuer (user) to be used by the card issuer to reference images or card designs at a later stage—such as from the embossing record 25 (which can be delivered to the embossing database 28).

In another embodiment, the upload page 40 could for example also include a field (not shown) for uploading various branding elements associated with the card issuer, which are to be stored in the new template. Such branding elements could for example include holograms, magnetic stripes and other physically placed elements on the transaction card along with the stock images. In an alternative embodiment, rather than using separate fields, the estimation of branding elements can be achieved through a pull down menu (not shown) of predefined branding element parts, for example “MASTERCARD with a hologram and a two track magnetic stripe”. According to another embodiment, a display of the designed card with images, branding elements, etc would also be shown by the interface (not shown) allowing the card issuer to view the branding elements in relation to the uploaded images. The advantage of this is that it allows the card issuer to view an accurate graphical simulation of the finished card over such an interface.

Although FIG. 4 shows an upload image page which allows for images to be uploaded in pairs (i.e. the image for the card front and back together), it should also be appreciated that images can be uploaded individually, for example by only entering one of the fields such as the image associated with either the front or the rear face of the card.

According to a further embodiment, the card issuer may also set business rules for this interface to ensure for example that card images: uploaded in pairs, all card images front images are associated with a single predefined card back image, or for example one card front image being associated with several card backs. An advantage of setting up such a set of business rules is that the card issuer is able to have further control over a range of their products which are limited by these said business rules. This might result in cheaper manufacturing costs and/or data entry by low level personnel who will not be allowed to upload images not compatible with products defined by the business rules preset by the card issuer. Thus, the card issuer is able to define certain card types (i.e. products) having associated images and/or branding.

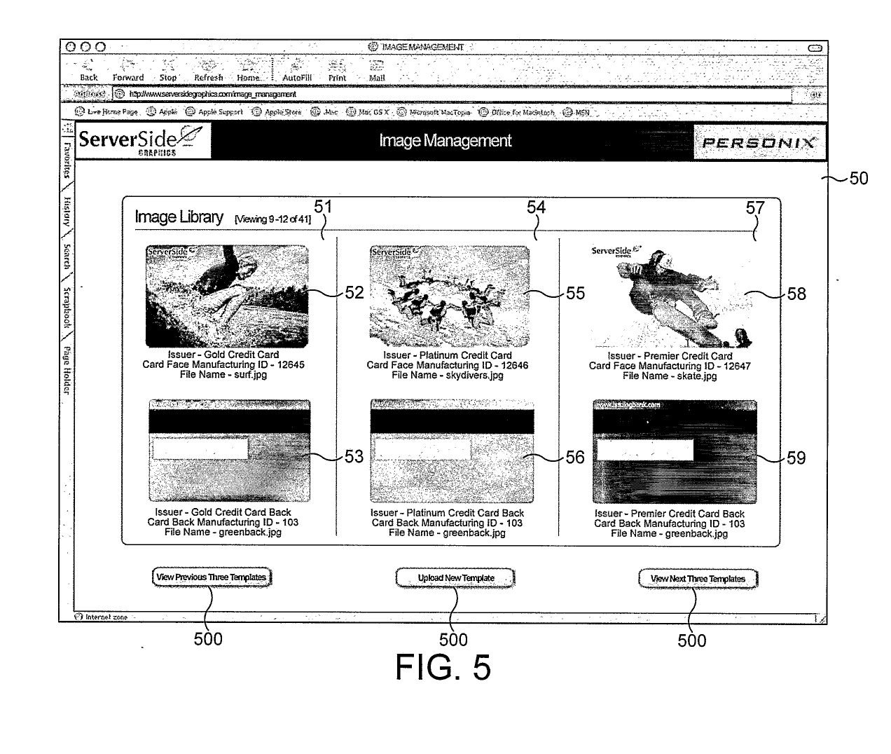

FIG. 5 shows an image library interface according to an embodiment of the present invention allowing card issuers to remotely view and manage their stock card images which have been uploaded into the image database 26.

In the particular embodiment shown in FIG. 5, the stock card images are displayed in templates (i.e. pairs) with the image to be displayed on the card front being displayed along with the associated image to be displayed on the back of the card.

Thus, the image library interface 50 shown in FIG. 5 displays three templates 51, 54 and 57. Each template comprises a pair of images, wherein the first template 51 comprises a front image 52 and a rear image 53, the second template 54 comprising a front image 55 and a rear image 56, and the third template 57 comprising a first image 58 and a second image 59. The image buttons 500 at the bottom of the screen allow a user to navigate through more templates that are stored in the image database 26.

In a embodiment of the present invention, images may be displayed in reverse order of upload with the newest images being displayed first. Moreover, beneath each image, information associated with that image can be displayed. For example take the front image 52 associated with template 51 for a particular card. This image is associated with a particular type of card “Gold Credit Card”, an associated UID “12645”, and the original file name “surf.jpg”. The interface or webpage 50 of the ASP 6 also displays to the card issuer 8 a viewing range (i.e. viewing 9-12 of 41) which allows the user to skip forward to any given template stored in the image library of the database 26. The user may choose to move forward or backwards through the image library using the “view next templates” or “view previous templates” buttons 500.

The user may also select an image template by clicking on it, which may result in the rest of the image templates on screen becoming inactive. Once a specific image template is selected, an image status appears at the bottom of the page (not shown) to denote whether an image is either active or inactive. Inactive templates cannot be queued for print batching without first being activated. The advantage of such a feature is to ensure that only current images are able to be printed. For example, a card manufacturer 10 may have a print capabilities which are not capable to produce a selected image (or template) for a transaction card, in which case it would be useful to deactivate such images before they get selected for the printing process.

If a template is inactive it may then be deleted from the system as required once the card issuer can be sure that no further cards will be issued requiring such a template. Higher level users at the card issuer, for example administrators, may be asked to confirm image deletion before this is done and moreover deleted images can be kept in a deleted image table within a database if it is decided to activate these images at a later stage.

Before a template or image associated with a particular card can be deleted, the card issuer must be informed to ensure that there are no further requests for such a card type. If an image (template or card type) is requested that no longer exists then this will be communicated to the card issuer 10, for example as an exception handling process.

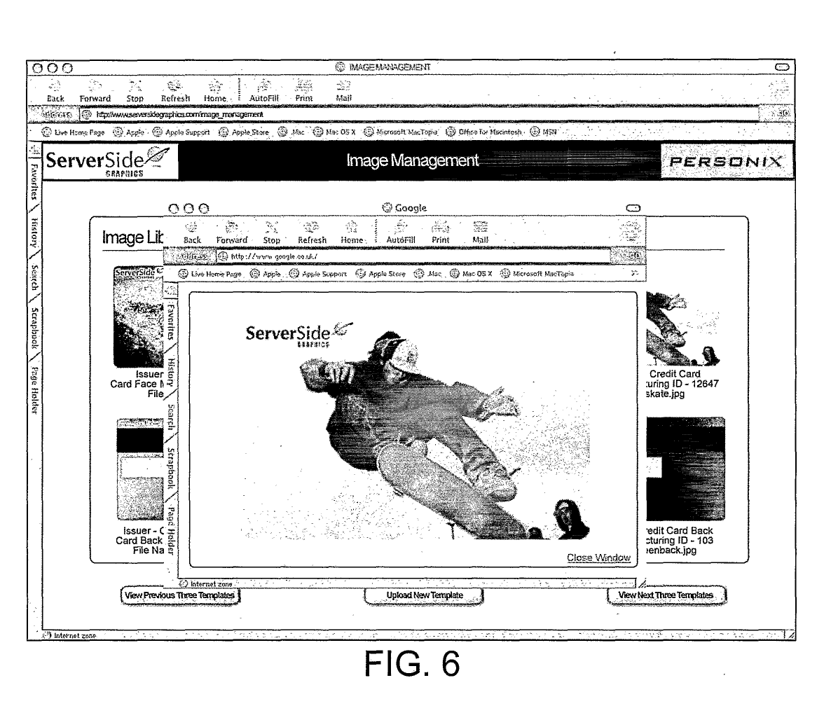

FIG. 6 shows an interface wherein by double clicking on an image of a template the user may also view the printable image in a larger image resolution, which will appear in a new browser window. Thus, FIG. 6 shows that the image 58 has been selected by a card issuer and enlarged in a new browser window 61.

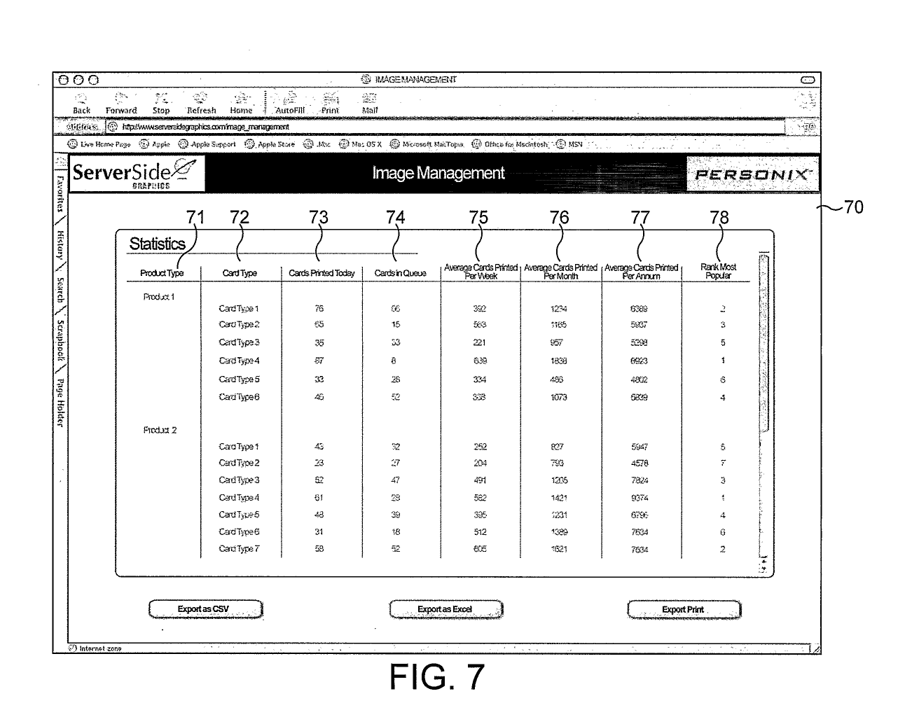

FIG. 7 shows a further interface of an ASP 6 to be viewed by a card issuer 10. Specifically, FIG. 7 shows a reporting page 70 comprising a plurality of statistical metrics that can describe which images, card types, etc are the most popular and which are the least popular. For example some of the metrics include: cards printed to date 73, cards in queue 74, average cards printed per week 75, average cards printed per month 76, average cards printed per annum 77 and ranking of the most popular card types 78. Such metrics are grouped according to respective card types 72 which in turn form subgroups of respective product types 71.

Thus, the marketing functionality 22 of a card issuer 8 can find this information useful in determining which images, card types 72, products 71 etc are most popular and which others can be deactivated since they are rarely used.

In a further embodiment, metrics from the reporting page 70 can be exported in a different format which might be preferred by a relevant card issuer 8. It should be appreciated that the reporting page can be exported in a CSV (comma separated variable) format, a spreadsheet format (for example Microsoft Excel 2003), exported to a local print device, etc.

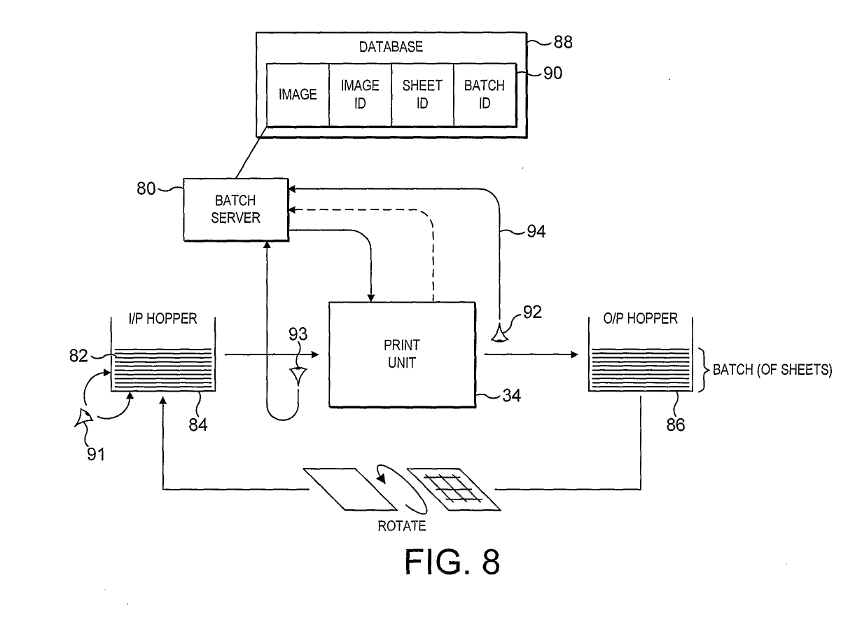

FIG. 8 shows a printing system according to a preferred embodiment of the present invention. The print system comprises a print unit 34, which is also shown in FIG. 3.

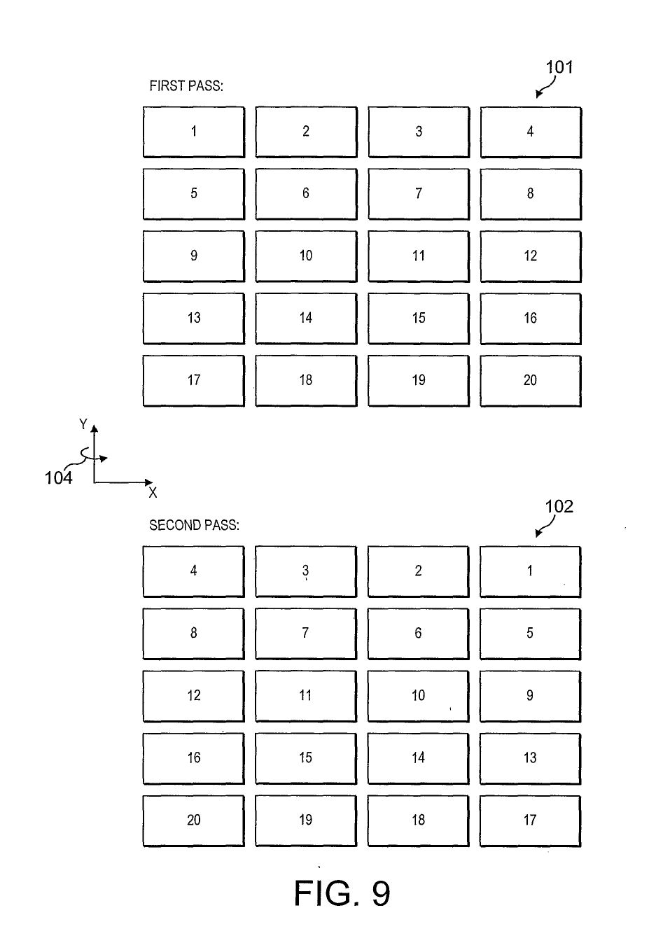

The print unit is capable of receiving card sheets 82 which are stored and fed from a input hopper 84. In a preferred embodiment, the card sheets comprising for example a material forming the basic substrate of a credit card on which the images are printed, wherein the sheets have a particular physical size and wherein in a preferred embodiment a plurality of images will be printed on a single sheet. The plurality of images being printed on specific locations on the sheet as defined by some predetermined grid pattern which can be stored in either a batch server 80 or the print unit itself 34. FIG. 9 shows a 4×5 group pattern for each sheet. That is, for the first printing part 100 shown in FIG. 9 it can be seen that the card sheet has a group pattern comprising four columns and five rows of images.

It should be appreciated that there are various methods for creating discrete individual cards from the card sheet, for example wherein the grid pattern defines rectangular shapes (of standard CR-80 or other size) at locations on the card sheet and after printing each image at these locations, the card can be punched out of the relevant rectangular—this process being referred to as die-cut.

Once images have been printed onto a sheet at locations specified by the grid pattern, the printed sheets are output to an output hopper 86 where they are maintained in the correct physical order in which they were received. A batch server 80 is able to control the printing apparatus for example by having connections to the print unit 34. The batch server 80 also having a connection to a database 88 which is able to take the information read by the read device 92 and match it up with relevant records 90 stored in the database 88.

It should be appreciated that the database 88 could be stored in the batch server 80 itself or alternatively can be the image database 26 associated with the ASP.

According to a preferred embodiment, each card sheet is subjected to a duplex (i.e. two-part) print process through the print unit 34. In a first print pass, each card sheet 84 is fed to the print unit 34, wherein the print unit 34 is also able to receive a plurality of images downloaded from the batch server 80 as well as information describing the predetermined grid pattern and size of the card sheets to be printed on. Thus, in the preferred embodiment shown in FIG. 9, the images are laid down in a 4×5 grid pattern, i.e. four columns and five rows of images per sheet. However, it should be appreciated that other grid patterns are equally applicable, for example 3×7, etc. The predetermined grid pattern being stored, for example in the batch server 80 and being programmable.

The print unit 34 prints the first set of images received from the batch server 80 at locations defined by the grid pattern, but according to some particular order, which is also in a preferred embodiment provided by the batch server 80. Thus, viewing sheet 101 of FIG. 9 it can be seen that after a first pass the first row of images is printed from left to right, i.e. image 1 is printed on the far left followed by image 2 followed by image 3 and finally image 4 on the far right of the card sheet, whereafter image 5 is printed on the next row of the grid pattern at the left-most location. This order is important in determining the order for the second print pass.

After the first print pass, the printed image is then output to an output hopper 86. Because a transaction card can have a pair of images for the respective front and rear faces, for example corresponding to a template stored in the database 26, the rear face (or inverted face of the printed card sheet) also needs to be printed on. Moreover, one needs to ensure that the correct rear images are printed at the corresponding locations associated with their front images.

In an embodiment of the present invention, in preparation for the second printing pass, the contents (i.e. sheets) of the output hopper 86 are reloaded into the input hopper 84 and physically orientated before the second pass printing occurs.

According to an embodiment the following steps are undergone:
the contents of (i.e. sheets) of the output hopper are maintained in the direct physical order in which they were printed,
the sheets are lifted out of the output hopper and inverted about a standard axis,
the physical orientation of the inverted card must stay the same and the images must be printed according to the same group pattern, however the order in which images are to be printed in the group pattern needs to be different so that the correct images of the rear face of a transaction card printed on the back of the location associated with the corresponding front image of a transaction card.
in order to ensure that the correct images are printed on to the correct back, a barcode reader 91 is used to read the first and last sheet barcodes whether as part of an image or, in an alternative embodiment, on the sheet itself rather than the image. This step requests the correct images to be printed from batch server 80.

In the embodiment shown in FIG. 9, for example the sheets are taken from the output hopper and inverted about a y-axis 104 which corresponds to the long edge of each sheet.

However, the batch server 84 needs to run an algorithm which is able to take into account the type of inversion performed and change the print order so that the images printed in the second pass are printed at the same locations defined by the grid pattern but in a different order to the first pass, so as to match up the images printed in the second pass at the associated images locations printed in the first pass.

The bottom half of FIG. 9 shows a card sheet 102 in which an algorithm has executed in the batch server and thereby changed the order in which the images are printed according to the inversion. Specifically, it will be seen that in order to print the correct rear image on sheet 102 associated with image 1 on sheet 100, it will be necessary to reverse the order of printing so that the rear image of image 1 is now printed closest to the right margin (as compared to for the first print pass where it was printed closest to the left margin). Similarly, the order of printing images 2, 3 and 4 and all of the other rows corresponding to the inverted sheet 102 need to be reversed so that printing of the rear images coincides with their corresponding front images.

It should be appreciated that in another embodiment of the present invention, batch prints will be performed wherein a plurality of sheets are printed in batches. In order to ensure that the inverted pages are correctly orientated, before the input hopper loads the sheets 84 into the print unit, the first and last sheets of each batch will be scanned using a tethered barcode reader 91 to ensure that the correct image back is printed on the correct image front. By storing a list of the images on a sheet (front and back) and the sheets in a batch it is possible to infer from the read of the top sheet and the bottom sheet what the all the sheet in between will be.

However, In a preferred embodiment the images would be read automatically as they move towards the print unit 34 by reader 93 and the duplex images (i.e. the alternative images to be printed on the back of the sheet entering the machine) would be called from the database 88 “on the fly”.

Each printed sheet must also be loaded into the input hopper face down but with a specified edge of the sheet in the identical orientation to the first print pass.

According to a further embodiment, as each printed sheet passes through the print unit 34 into the output hopper 86, a barcode imbedded within the image, or placed on the sheet of images, in a consistent orientation in respect of the sheet, is read by a barcode reader 92. This is to ensure that the print has been successful. Note that this information could also be received from the print unit itself.

In a preferred embodiment, the reader 92 may be physically affixed to the print unit 34 via a mount bracket, which will position the reader 92 above the output hopper 86 and will be capable of reading the UV wavelength (such as 610 nanometres) so that the barcode need not be visible to the human eye.

For each successful read, a barcode scanner 92 sends a response to the batching server 80 along line 94. This response, which is delivered as a so-called flat file, contains alphanumeric data encoded within the barcode. Such alphanumeric data corresponding to a UID for a particular image whereby the batch server is able to access the database 26 and determine whether there is an associated rear image which also needs to be printed.

Should a sheet, or an image printed on the sheet, be unsuccessfully read by the reader 92, an error message is flagged to the batch server 80 indicating that a manual read (for example with a handheld scanner or by entering the digits into a workstation manually) is required. Thus, the reader 92 also advantageously provides an audit procedure for checking whether images have been printed correctly.

According to an embodiment of the invention, the batch server 84 could for example comprise a state engine (not shown) which performs a state change in response to registering that the face of a particular transaction card has been printed and that it is either awaiting the second part of the printing process in order to print the back image of the card or, if the back image has already been produced via, for example offset printing methods, then the second pass of the printing process will not be required. This could also be achieved by receiving feedback from the print device.

In summary, having completed the first pass, each printed sheet must be reloaded into the input hopper 84 for a second pass. Before loading the sheet into the input hopper 84, the barcode imbedded either within one of the images, or in an alternative embodiment on the sheet itself of the first and last page of the batch, is read by a barcode reader.

Based on the information scanned by the read device 91 (or 93), the correct batch of images will be downloaded from the batch server 80 to the print unit 24 for the second print pass. The barcode will therefore contain either implicitly or through cross-referenced information in the database 26, the following information: i.e. a unique card identifier, a sheet identifier, a batch identifier or additionally it may contain a pair of image identifiers associated with the front and back images of a template, an image identifier associated with a back image or an image identifier associated with a front image.

As each printed page passes through the print unit 34 for the second pass into the output hopper 86, the barcode imbedded within the newly printed image, or in an alternative embodiment on the top right edge of the sheet, is read by a fixed barcode reader 92.

Again, information obtained from read device 92 can be sent to the batch server 94 and a further status change in the state engine (of the batch server) can be updated to reflect that both the back and front images of the relevant transaction cards have now been completed. This ensures that the system is aware at any given moment of the status of all the images, sheets and batches of sheets that are moving through the system.

The particular reason for the use of batches is that as there may be a subsequent process to affix holograms, magnetic strips and other branding elements which can be time consuming to set up for each process (such as Hand Tacking). Similarly, although batches of cards may be of different card types, they have similar attributes to be affixed in these subsequent stages (i.e. holograms, magnetic strips, branding) which is of great utility to the process.

In an alternative embodiment, the sheets are not inverted or returned on the feedback line 83 from the output hopper 86 to the input hopper 84. Instead, the transaction cards are produced by printing two separate sheets which are merely placed together after printing. Thus, although a second printing pass is also performed wherein the same orientation information needs to be set up in the print unit 34 before printing the second pass, it is no longer required that the sheets printed during the first pass be required for the second pass.

It should be appreciated that the information which is read by the reader 92 can take on a variety of different forms. In one embodiment, the information could be a UID which has been converted into an optical format, using, for example, a barcode, text, microdot, microtext, invisible ink, or other technique, and embedding the optical format identifier (OID) as part of the digital image to be applied to the card; for example by printing the OID into the image itself. The OID may also be printed in two or more different optical formats, or multiple times in the same format, so that it can be read in the event of a mis-scan.

Also such information could comprise a list of UID's corresponding to the images printed on the sheet, which is printed for example somewhere on the sheet, for example the top-right hand corner. Again, the UID can either be printed in humanly-readable or machine-readable form.

However, it should be apparent that the read devices, for example the reader 92, will need to be able to read the information. So in the case of an OID, for example a barcode embedded in each image, a relevant bar-code reader is needed for the read device 92 to be able to read the OID and recover the UID embedded in the image.

In any event, the information which is read by the read device is sent to the Batch server 80 in FIG. 8. The batch server 80 is connected to a database 88 comprising a cross-reference table wherein the information read from the read device 92 can be tied up with other information. So for example, table 90 shows fields which are able to correlate an image with an associated image identifier (UID), sheet identifier or a batch identifier. In this way it is possible for the batch server to read the information from read device 92 and extract the relevant information from table 90 in order to control the subsequent printing process and/or their configuration. For example, the read devices 92 is able to read all the images on a sheet and from this extract from the database table 90 the relevant images to be printed on the back of the sheet and at which locations. The batch server is then able to control the subsequent printing processes by taking into account, for example: the type of inversion (if indeed performed) and/or the new order of printing the back images so that they are printed at the correct locations and/or the orientation. It should be appreciated that the database 90 is connected to the database 26 of FIG. 3.

According to another embodiment of the present invention and referring back to FIG. 3, it can be seen that there are various successive stages through which a transaction card proceeds in order to be completed and then sent off to the card holder 50.

Some of these stages of manufacture are shown in FIG. 3 wherein for example the print unit 34 begins the process by printing images that have been stored in the image database 26. Such images either comprising images created by a user 4 via manipulation software inside the APS 6 or stock images uploaded by a card issuer 8. Block 30 in the flow diagram indicates the process which triggers the printing and manufacture of a transaction card. FIG. 3 shows that there are various inputs 11, 301, 302 to the trigger module 30 which might initiate the manufacture process.

Specifically, these trigger processes can broadly be broken down into the following: i) wherein a valid embossing record associated with the UID or stock UID is present in the embossing database 28 (such UIDs being associated with corresponding images stored in the database 26) or ii) if one of the audit exceptions 31, 33, 35, 37 or 39 have been generated and are supplied along line 11 as an input to the trigger module 30. Thus in more detail for i), referring to FIG. 3 where a unique image or stock image has been received in the database 26 having been selected 21 by a user and the business rules allow the assumption that the embossing record, with a reference to this image, will follow, then the trigger module 30 is triggered.

If we assume that a valid embossing record is available in the embossing record database 28, then the associated record in the image database 26 comprising the image and the associated UID is sent via module 15 to the print unit 34. It should be appreciated that the block module 5 could for example incorporate functionality of the batch server 80 shown in FIG. 8 and is able to receive a batch of images associated with a plurality of transaction cards that require printing and/or manufacture. The images are then sent to the print unit 34 and after being printed, their respective images are scanned by a barcode reader which determines whether the image has printed correctly. For example, if the barcode reader is unable to read the barcode, it is likely that the image has printed poorly and the card will need to be reprinted in which case an exception is generated along line 31.

It should be appreciated that an exception could also be generated in the circumstance where the image printed is not the correct image for that transaction card, i.e. a processing error of some kind has occurred, in which case the card and/or the batch need to be reprinted.

This process of having a barcode reader located at each successive stage of manufacture is useful in that any errors in the production process can be detected early on with the advantage that further resources are not unnecessarily wasted by further processing the already damaged card.

Another option that is available is to have a wireless barcode reader which may mean that a single reader can be used in a variety of ways as it will be easily portable.

It should be appreciated that a flexible configuration of read devices can be employed, so that for example a two-reader configuration can be setup for simultaneously reading and therefore checking both sides of a transaction card, i.e. the front and rear image and sending this information back to the database 88 for confirming whether the correct images have been printed. Thus for example, a user may have selected a specific card type with a selected template having associated front and rear images. The two-reader arrangement allows both faces of the card to be simultaneously checked.

FIG. 3 shows module 36 which applies a number of processes such as die-cutting, applying a varnish to the transaction card, applying a magnetic stripe to the transaction card and applying a signature panel to the transaction card. Again a barcode reader can read the process transaction card after each of these stages to confirm if the card is still valid.

Likewise, a barcode reader is also placed after the further stage 38 wherein the magnetic stripe applied in previous stage 36 is now encoded with the read UID, or alternatively with other information associated with the UID that can be obtained by cross-referencing the UID in the image database 26. Any detected errors can be flagged along line 35.

A further barcode read is performed after stage 40 wherein the encoded magnetic stripe is now read and from it the relevant embossing record is extracted from the embossing record database 28. Any detected errors can be flagged along line 37.

Finally, at stage 42 the finished card is ready to leave the personalization bureau, but just before it does a final barcode check is performed and if there is any problem an exception is raised along line 39.

According to one embodiment, the read device 92 reads the image or sheet printed in each stage of the production process, and sends this information back to the one of the databases 26 or 28, which are in turn connected to the database 90. This read sends a command to the database, which will know the expected state of the image. If the state does not agree with the read information then the printed image has failed at some point in the process and the state of the image is set back to the start, at trigger module 30, where the card will need to be reprinted.

In a further embodiment, there is the further option of entering the UID manually if the read device 92 cannot read the image, in which case the audit process flags that that a particular image (or card associated therewith) has not been sent out and therefore needs to be re-printed.

In an alternative embodiment, instead of using a barcode reader at the output of each successive stage of manufacture, it is possible to manually input the UID using for example, via a keyboard or other data input device.

Thus, the audit process is able to perform a check after each of the successive stages of manufacture and if there is a problem an exception is flagged. Transaction cards which are damaged between arrival at the production facilities and the completion of the embossing process must be accounted for and reprinted.

The barcode reader will be situated close to each of the devices associated with successive stages of manufacture, since this is the most likely point for cards to be damaged. The barcode reader may either connected to a local PC which could facilitate the manual input of a barcode in the instance where none of the barcodes printed on the card are mechanically readable, or have a direct connection to the batching server 84.

For each unsuccessful read, the barcode scanner sends a flat file to the batching server 80. The batching server then feeds the images and associated UIDs (for the various transaction cards to be manufactured) back to the printed batch queue of the print unit 34 to be reprinted with the next suitable batch.

According to a further embodiment there is provided a method for identifying a spoiled card(s) and re-running parts of the production cycle, for example where one of the cards in a sheet (or batch of sheets) is mangled in the die-cutting process which happens occasionally when card are punched out of the printed sheets. Indeed, it should be appreciated that sometimes a sheet or batch may be spoiled. In such cases, a monitoring device, for example a camera unit or human operator is able to observe a potentially spoiled card and for example a handheld scanner can be swiped across the spoiled card and from the extracted information, a control system is automatically able to generate an exception record wherein the card is reprinted by sending the information on which card or cards are spoiled, to an input queue for reprinting. For example, the images can be queued in the input hopper 84.

It should be appreciated that the information that can be scanned and/or extracted from the database 88 for example, can comprise a UID associated with each image or a type of card, a sheet identifier, a branch identifier, etc.

According to a further embodiment, the encoding stage 38 is likely to have a plurality of barcode scanners. Specifically, a first barcode scanner is needed at the input of stage 38 in order to read the UID and then the right circuitry is required in order to encode this information into the magnetic stripe applied to the card during the previous stage 36. In a preferred embodiment (especially where the duplexing of cards is inferred through a batch process), an additional pair of barcode readers may be used to perform the auditing process on the stage 38, wherein the pair of barcode readers reads both sides of the card and ensures that the front and back images were correctly paired up during the two-pass printing process.

According to another embodiment, after the final embossing stage 40, a barcode reader can be used to present a file audit report informing a user of the system (for example, either the card issuer or card producer) that a transaction card has been correctly dispatched or the status of when it is due to be dispatched. This information can also then be reported back to the database 26 connected to the ASP 6 and presented for example to the card issuer via the metric webpage shown in FIG. 7.

As noted previously, the trigger for module 30 for the printing of an individual card is the delivery of an embossed record, or delivery of personalised image or the receipt of an exception resulting from an error that has occurred during the manufacture of a previous card. The embossed record will include either a UID which relates to an image designed by a user (i.e. a personalized image designed using software provided by the ASP 6) or a card type UID which relates to a stock image uploaded by a card issuer (using software provided by the ASP 6). In both cases, this information will be held in the embossed record or a cross-referenced file to the embossed record.

Different embodiments are likely to occur, for example in the instance of a personalized card, the embossed record will contain both a UID for the image on the front of the card and a card type UID relating to the image on the back of the card.

In another embodiment, the card type UID is related to a personalized card, but if the personalized image is not available, then there will be a default stock image which is made available for the front of the card. Thus, even if a particular card is shown and allows particular card types to be designed by a user, the card issuer is still able to upload a default card type which comprises the default stock images for both the front and back of the card.

1. A service provider connected to a database for storing a plurality of images having associated unique identifiers, the service provider comprising:
a first interface for enabling a user to select at least one of the plurality of images to be displayed on a transaction card;
a second interface for enabling a card issuer to upload a stock image to the database.

2. The service provider of claim 1, wherein the second interface further enables a card issuer to assign a unique stock identifier to said stock image.

3. The service provider of claim 1, wherein the service provider further comprising the step of:
generating a unique stock identifier which is assigned to said uploaded stock image.

4. The service provider of claim 1, wherein the stock image is also selectable by the user via the first interface once said stock images and associated unique stock identifiers have been loaded into the database.

5. The service provider of claim 1, wherein the first interface further enabling the user to manipulate the plurality of images in the database.

6. The service provider of claim 1, wherein the second interface further enabling the card issuer to upload a template comprising a pair of stock images to be displayed on a respective front and rear face of the transaction card.

7. The service provider of claim 1, wherein the second interface having a set of rules that determine which of the stock images are uploaded.

8. The service provider of claim 1, comprising a third interface for enabling the card issuer to view the stock images stored in the database.

9. The service provider of claim 8, wherein the third interface is further arranged to display along with each stock image stored in the database, at least one of a type of the card issued by the card issuer, the assigned unique stock identifier and a filename of the image.

10. The service provider of claim 1, comprising a fourth interface for enabling the card issuer to view a statistical report indicating which types of card are most popular.

11. The service provider of claim 10, wherein each type of card being defined according to the images on at least one of its back and rear faces and wherein a plurality of different metrics indicate a quantity of types of card selected by the user over a period of time.

12. The service provider of claim 1 comprising further interfaces enabling the card issue to perform at least of activating, deactivating and deleting the uploaded images in the database.

13. The service provider of claim 1 wherein the interfaces are web pages.

14. The service provider of claim 1, wherein access to each interfaces is protected by, a login requiring a username and a password.

15. The service provider of claim 1, wherein the service provider comprises the database.

16. A method for uploading a stock image to a database which is able to be selected for display on a transaction card, the method comprising:
selecting the stock image at a card issuer;
uploading said stock image from the card issuer to the database; and
selecting from said database a stock image to be displayed on a transaction card.

17. The method of claim 16, wherein the step of selecting further comprises assigning a unique identifier to the stock image and uploading and uploading the stock image with the assigned unique identifier to the database.

18. The method of claim 16, further comprising the step of generating a unique identifier associated with a type of transaction card.

19. The method of claim 18, wherein the type of card is defined by a front and back image of the transaction card in the database.

20. The method of claim 18, wherein the type of card is reported back to a user which is able to select over a first interface from a plurality of types of card.

21. The method of claim 16, wherein at least one of a plurality of holograms and magnetic stripes are associated with a card type and being commonly demarcated through a unique identifier.

22. The method of claim 16, wherein at unique identifier is used as a reference to a card type within an emboss record.

23. The method of claim 16 wherein the database is in a service provider and wherein said step of uploading is performed over a first interface between the card issuer and the service provider and said step of selecting is performed over a second interface between a user and the service provider.

24. A method of printing images on sheets, the method comprising:
receiving a sheet fed from an input hopper;
printing a first set of images onto the sheet at locations defined by a predetermined pattern in a first order, and wherein duplex data is also printed onto the sheet;
reading said duplex data printed on the sheet; and based thereon,
orientating a next sheet so that a second set of images is printed at the locations defined by the pattern in a different order.

25. The method of claim 24, wherein the first set of images comprises different images to be displayed on a plurality of corresponding transaction cards.

26. The method of claim 24, wherein the first set of images are to be displayed on one of the front and rear face of a plurality of corresponding transaction cards.

27. The method of claim 26, wherein the second set of images are to be displayed on the other face of the plurality of corresponding transaction cards.

28. The method of claim 24, wherein the duplex data is embedded in at least one of the images.

29. The method of claim 24, wherein the duplex data is printed on the sheet.

30. A method of printing a plurality of images for transaction cards each having a rear and front face capable of displaying an image, the method comprising:
a first pass printing process for printing a first set of images for one of front and rear face of the cards, wherein at least some of the first set of images are different and wherein the first set of images are printed on a sheet in a predetermined grid pattern at locations according to a first configuration;
inverting the sheet about a predetermined axis;
a second printing pass for printing a second set of images for the other face of the cards on the inverted sheet, wherein at least some of the second set of images are different, and wherein the second set of images are printed in the predetermined grid pattern at locations according to a second configuration.

31. The method of claim 30, wherein the each image in the first set having an associated image in the second set and wherein the second configuration being such that each of the second set of images is printed on the other face of the transaction card corresponding to at least one of the front and rear face of the associated first set of images printed in the first pass.

32. The method of claim 30, wherein each sheet bearing a marker for indicating an orientation of the sheet.

33. A printer apparatus connected to a database for a plurality of images and unique identifiers associated with each image, the printer apparatus comprising:
an input hopper for feeding a sheet;
a print unit for receiving each sheet and printing thereon a first set of images at least some of which are different, in a first order at locations defined according to a predetermined pattern, and printing information on the sheet;
an output hopper for maintaining the printed sheets sequentially; and
a reader for reading the information and based thereon, orientating the next sheet so that a second set of images is printed at the locations in a different order.

34. The printer apparatus of claim 33, further comprising an output hopper for receiving the printed sheets and maintaining the sequence the sheets were received.

35. The printer apparatus of claim 34, wherein the reader is mounted on the print unit and located between the print unit and the output hopper.

36. The printer apparatus of claim 33, wherein the reader is a barcode reader and the unique identifier is embedded in a barcode.

37. The printer apparatus of claim 33, further comprising:
a batch server for controlling the print apparatus and arranged to perform an action for orientating the next sheet based on the unique identifier read in the sheet.

38. The printer apparatus of claim 37, wherein the information read by the reader effects a change in a state of a batch server from the first to second pass.

39. The printer apparatus of claim 33, wherein the information comprises the unique identifier and relates to at least one an image, a type of card, a sheet or a batch of sheets within the database.

40. The printer apparatus of claim 39, wherein the change of state effects a change for the subsequent printing of at least one of the image, the type of card, the sheet or the batch of sheets.

41. The printer apparatus of claim 36, wherein the barcode is delivered in UV ink.

42. A method for checking the validity of a transaction card as it proceeds through successive stages of manufacture, the method comprising:
printing an image and a unique identifier associated with that image on a transaction card;
proceeding through each stage, wherein after each stage, the unique identifier is checked; and based thereon identifying whether at any stage the card is invalid thereby generating an exception and preventing the card from proceeding to any successive stages.

43. The method of claim 42, wherein the remanufacturing involves destroying the invalidated transaction card and proceeding through the successive stages of manufacturing a new transaction card.

44. The method of claim 42, wherein the step of checking is performed after each stage by comparing the read unique identifier with that stored in the database and changing the state of the image, sheet or batch within the database.

45. The method of claim 42, wherein successive stages of manufacture comprise at least one of: die cutting, applying branding, encoding of the magnetic strip with the unique identifier, embossing, and a final check on completed transaction card just before delivery.

46. The method of claim 45, wherein the die cutting stage further comprises stages for applying at least one of: varnish, a magnetic strip, a hologram and a signature panel to the transaction card.

47. The method of claim 42, wherein the unique identifier is a barcode which is automatically read by a reader device at each stage.

48. The method of claim 42, wherein the unique identifier is manually input from a computer at each stage.

49. The method of claim 42, wherein the initial printing stage of manufacture is triggered by at least one of:
receiving in a database a record comprising the image and the unique identifier assigned to the image; and
receiving an exception which requires a remanufacturing of the invalid transaction card;
receiving an embossing record with an embedded unique identifier referring to an image.

50. A method of manufacturing a transaction card displaying a selected image, the method comprising:
proceeding through a sequence of manufacturing stages, wherein after each stage, a unique identifier associated with the image is checked;
generating an exception if the check is invalid; and triggering a new manufacturing sequence for a new transaction card in response to receiving the exception.

51. The method of claim 50 wherein if the check is valid, the triggering step being carried out in response to receiving in a database a record comprising the selected image and the unique identifier.

52. The method of claim 50, wherein images can be groped as card types, card types can be grouped as sheets and wherein the images, card types and sheets are grouped together as batches to ease the process of adding additional features such as holograms or magnetic stripes.

53. A method for checking the validity of a transaction card during production, the method comprising:
printing an image and a unique identifier associated with that image on a transaction card;
reading the unique identifier and based thereon checking whether the card is invalid; and wherein if the card is invalid,
raising an exception for discarding the card and returning to an upstream printing step for reprinting the image and the unique identifier.

54. The method of claim 53 being performed on the card which is completed but before being sent off to a user.

55. The method of claim 42, wherein a front image and a rear image is printed on the card, and wherein the step of checking is performed by two read devices which confirm that said respective front and rear images are correctly associated with each other on the printed card.

56. The method of claim 55, wherein the confirmation is done by checking a database to confirm that the front and rear images are correctly associated.

57. A method of producing a plurality of transaction cards, the method comprising:
providing an identifier associated with one or more cards in the production process;
monitoring production of the plurality of cards to observe at least one spoiled card;
reading said identifier to generate an exception record indicating at least one card needing to be re-printed; and
controlling the production process so as to automatically reconfigure a print queue to produce a fresh version of the or each spoiled card.

58. The method of claim 57, wherein the identifier is selected from one or more of a card identifier, a sheet identifier and a branch identifier.

59. The method of claim 53, wherein a front image and a rear image is printed on the card, and wherein the step of reading is performed by two read devices which confirm that said respective front and rear images are correctly associated with each other on the printed card.
